(19) United States
(12) Patent Application Publication
(10) Pub. No.: US 2026/0058911 A1
(43) Pub. Date: Feb. 26, 2026

(54) Utilizing deep learning for inline Uniform Resource Locator (URL) categorization

(71) Applicant: Zscaler, Inc., San Jose, CA (US)

(72) Inventors: Chenhui Hu, Boston, MA (US); Muhammed Salih, Bengaluru (IN); Miao Zhang, Palo Alto, CA (US); Kabir Nagpal, Bengaluru (IN); Rex Shang, Los Altos, CA (US); Jacob Bollinger, San Francisco, CA (US); Santhosh Kumar, Bengaluru (IN)

(73) Assignee: Zscaler, Inc., San Jose, CA (US)

(21) Appl. No.: 18/909,037

(22) Filed: Oct. 8, 2024

(30) Foreign Application Priority Data
Aug. 26, 2024 (IN) 202441064185

(51) Int. Cl. H04L 47/2441; G06F 16/955; G06F 16/958

(52) U.S. Cl. CPC H04L 47/2441; G06F 16/955; G06F 16/986

(57) ABSTRACT

Systems and methods for inline Uniform Resource Locator (URL) categorization include training a lightweight machine learning model to score content associated with unknown Uniform Resource Locators (URLs) to determine a category of the plurality of categories for each of the unknown URLs; deploying the trained lightweight machine learning model to a node in a cloud-based system for use in production; and utilizing the trained lightweight machine learning model to monitor traffic inline to categorize unknown URLs.

### FIELD OF THE DISCLOSURE

The present disclosure relates generally to networking and computing. More particularly, the present disclosure relates to systems and methods for utilizing deep learning for inline Uniform Resource Locator (URL) categorization, such as for use in a cloud-based security system for allowing/blocking Web requests based on the classified content.

### BACKGROUND OF THE DISCLOSURE

Network and computer security can be addressed via security appliances, software applications, cloud services, and the like. Each of these approaches is used to protect end users and their associated tenants (i.e., corporations, enterprises, organizations, etc. associated with the end users) with respect to malware detection, intrusion detection, threat classification, user or content risk, detecting malicious clients or bots, phishing detection, Data Loss Prevention (DLP), and the like. Also, Machine Learning (ML) techniques are proliferating and offer many use cases. In security, there are various use cases for machine learning, such as malware detection, identifying malicious files for further processing such as in a sandbox, user risk determination, content classification, intrusion detection, phishing detection, etc. The general process includes training where a machine learning model is trained on a dataset, e.g., data including malicious and benign content or files, and, once trained, the machine learning model is used in production to classify unknown content based on the training.

An example cloud security service is Zscaler Internet Access (ZIA), available from the assignee and applicant of the present disclosure. ZIA provides a Secure Web and Internet Gateway that, among other things, processes outbound traffic from thousands of tenants and millions of end users (or more). For example, ZIA can process tens or hundreds of billions of transactions or more a day, including full inspection of encrypted traffic, millions to billions of files every day. One important feature of this cloud security service is content classification and blocking/allowing transactions based on the classification of content. For example, every Uniform Resource Locator (URL) can be classified in any of a plurality of categories, and each user's transaction can be allowed or blocked based on associated policy for that category. The URL categorization is important, and new URLs are introduced continually. As such, there is a need for an automated, dynamic content classification approach.

### BRIEF SUMMARY OF THE DISCLOSURE

The present disclosure relates to systems and methods for utilizing Machine Learning (ML) for inline Uniform Resource Locator (URL) categorization, such as for use in a cloud-based security system for allowing/blocking Web requests based on the classified content. Various model optimizations described herein include an improved tokenization implementation, utilization of curated training data for training lightweight models to perform on par with larger models, language-based content filtering, and data leakage detection. By utilizing the described optimizations, the present URL categorization can be implemented inline in a cloud-based system without introducing undesirable latency.

In an embodiment, a method includes various steps, a node in a cloud-based system is configured to implement the steps, and a non-transitory computer-readable storage medium include computer-readable code stored thereon for programming one or more processors to perform the steps. The steps include training a lightweight machine learning model to score content associated with unknown Uniform Resource Locators (URLs) to determine a category of the plurality of categories for each of the unknown URLs (step 502); deploying the trained lightweight machine learning model to a node in a cloud-based system for use in production (step 504); and utilizing the trained lightweight machine learning model to monitor traffic inline to categorize unknown URLs (step 506).

The steps can further include obtaining curated data from URL transactions monitored by a cloud-based system; labeling the curated data for the URL transactions with a category of a plurality of categories that describe content of a page associated with the URL; performing preprocessing of raw Hypertext Markup Language (HTML) files for the URL transactions; extracting features from the preprocessed raw HTML files; and training the lightweight machine learning model based on the features. The steps can further include utilizing an improved tokenizer implementation. The curated data can include URLs, extracted text from the webpage, and its category as classified by the curator. The steps can further include performing inline language-based content filtering and performing URL categorization based thereon. The steps can include utilizing one of a plurality of machine learning models based on the language-based content filtering. The language-based content filtering can be performed during a preprocessing stage. An unknown URL can be bypassed based on the language-based content filtering. The steps can further include encoding website content into an embedding; and performing a cosine similarity check between a training dataset and a testing dataset to eliminate data leakage between the training and testing datasets. The lightweight machine learning model can be a Lightweight Bidirectional Encoder Representations from Transformers (BERT-tiny) model.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1A is a network diagram of a cloud-based system offering security as a service;

FIG. 1B is a network diagram of an example implementation of the cloud-based system;

FIG. 2A is a block diagram of a server that may be used in the cloud-based system of FIGS. 1A and 1B or the like;

FIG. 2B is a block diagram of a user device that may be used with the cloud-based system of FIGS. 1A and 1B or the like;

FIG. 3 is a diagram of a trained machine learning model in the form of a decision tree;

FIG. 4 is a flowchart of a model training process for URL content classification; and

FIG. 5 is a flowchart of a URL content classification process.

FIG. 6 is a graph showing the distribution of datapoints in a test set with the cosine similarity against its most similar counterpart in a training set.

FIG. 7 is a flowchart of an Inline URL categorization process.

### DETAILED DESCRIPTION OF THE DISCLOSURE

Again, the present disclosure relates to systems and methods for utilizing deep learning for inline Uniform Resource Locator (URL) categorization, such as for use in a cloud-based security system for allowing/blocking Web requests based on the classified content. The present disclosure describes various model optimizations including an improved tokenization implementation, utilization of curated training data, language-based content filtering, and data leakage detection. By utilizing the described optimizations, lightweight models can be utilized with high efficiency and accuracy to perform the present URL categorization inline in a cloud-based system without introducing undesirable latency.

### Example Cloud-Based System

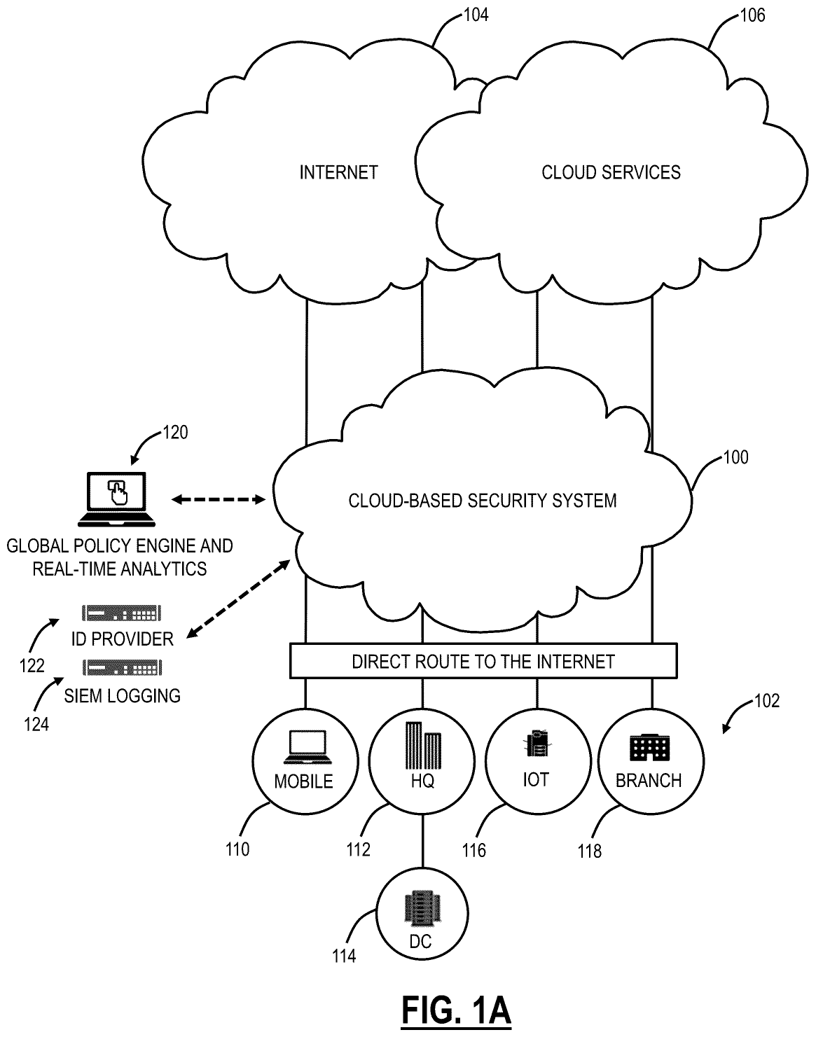

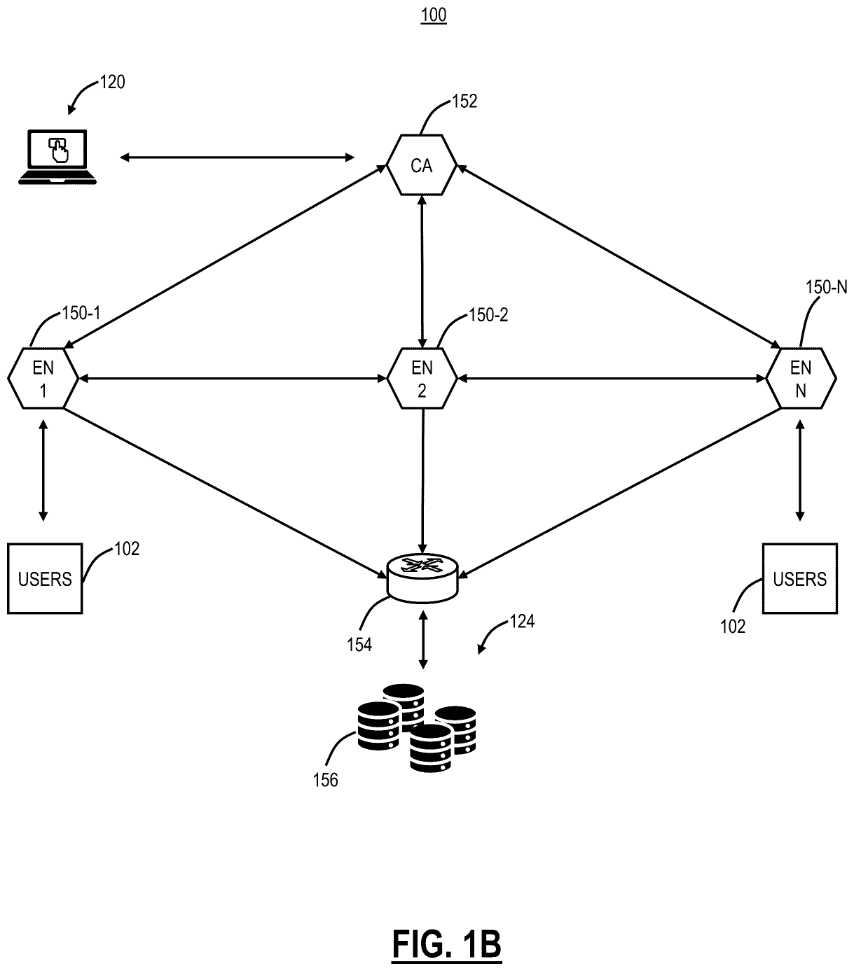

FIG. 1A is a network diagram of a cloud-based system 100 offering security as a service. Specifically, the cloud-based system 100 can offer a Secure Internet and Web Gateway as a service to various users 102, as well as other cloud services. In this manner, the cloud-based system 100 is located between the users 102 and the Internet as well as any cloud services 106 (or applications) accessed by the users 102. As such, the cloud-based system 100 provides inline monitoring inspecting traffic between the users 102, the Internet 104, and the cloud services 106, including Secure Sockets Layer (SSL) traffic. The cloud-based system 100 can offer access control, threat prevention, data protection, etc. The access control can include a cloud-based firewall, cloud-based intrusion detection, Uniform Resource Locator (URL) filtering, bandwidth control, Domain Name System (DNS) filtering, etc. The threat prevention can include cloud-based intrusion prevention, protection against advanced threats (malware, spam, Cross-Site Scripting (XSS), phishing, etc.), cloud-based sandbox, antivirus, DNS security, etc. The data protection can include Data Loss Prevention (DLP), cloud application security such as via Cloud Access Security Broker (CASB), file type control, etc.

The cloud-based firewall can provide Deep Packet Inspection (DPI) and access controls across various ports and protocols as well as being application and user aware. The URL filtering (content classification) can block, allow, or limit website access based on policy for a user, group of users, or entire organization, including specific destinations or categories of URLs (e.g., gambling, social media, etc.). The bandwidth control can enforce bandwidth policies and prioritize critical applications such as relative to recreational traffic. DNS filtering can control and block DNS requests against known and malicious destinations.

The cloud-based intrusion prevention and advanced threat protection can deliver full threat protection against malicious content such as browser exploits, scripts, identified botnets and malware callbacks, etc. The cloud-based sandbox can block zero-day exploits (just identified) by analyzing unknown files for malicious behavior. Advantageously, the cloud-based system 100 is multi-tenant and can service a large volume of the users 102. As such, newly discovered threats can be promulgated throughout the cloud-based system 100 for all tenants practically instantaneously. The antivirus protection can include antivirus, antispyware, antimalware, etc. protection for the users 102, using signatures sourced and constantly updated. The DNS security can identify and route command-and-control connections to threat detection engines for full content inspection.

The DLP can use standard and/or custom dictionaries to continuously monitor the users 102, including compressed and/or SSL-encrypted traffic. Again, being in a cloud implementation, the cloud-based system 100 can scale this monitoring with near-zero latency on the users 102. The cloud application security can include CASB functionality to discover and control user access to known and unknown cloud services 106. The file type controls enable true file type control by the user, location, destination, etc. to determine which files are allowed or not.

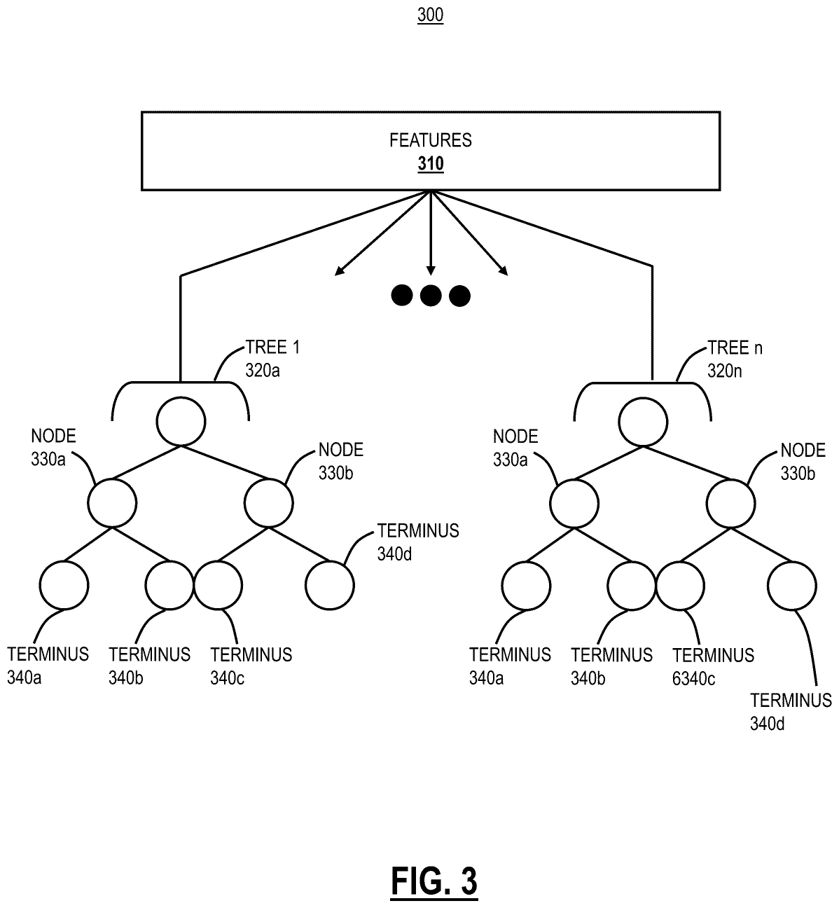

For illustration purposes, the users 102 of the cloud-based system 100 can include a mobile device 110, a headquarters (HQ) 112 which can include or connect to a data center (DC) 114, Internet of Things (IoT) devices 116, a branch office/remote location 118, etc., and each includes one or more user devices (an example user device 300 is illustrated in FIG. 3). The devices 110, 116, and the locations 112, 114, 118 are shown for illustrative purposes, and those skilled in the art will recognize there are various access scenarios and other users 102 for the cloud-based system 100, all of which are contemplated herein. The users 102 can be associated with a tenant, which may include an enterprise, a corporation, an organization, etc. That is, a tenant is a group of users who share a common access with specific privileges to the cloud-based system 100, a cloud service, etc. In an embodiment, the headquarters 112 can include an enterprise's network with resources in the data center 114. The mobile device 110 can be a so-called road warrior, i.e., users that are off-site, on-the-road, etc. Further, the cloud-based system 100 can be multi-tenant, with each tenant having its own users 102 and configuration, policy, rules, etc. One advantage of the multi-tenancy and a large volume of users is the zero-day/zero-hour protection in that a new vulnerability can be detected and then instantly remediated across the entire cloud-based system 100. The same applies to policy, rule, configuration, etc. changes-they are instantly remediated across the entire cloud-based system 100. As well, new features in the cloud-based system 100 can also be rolled up simultaneously across the user base, as opposed to selective and time-consuming upgrades on every device at the locations 112, 114, 118, and the devices 110, 116.

Logically, the cloud-based system 100 can be viewed as an overlay network between users (at the locations 112, 114, 118, and the devices 110, 106) and the Internet 104 and the cloud services 106. Previously, the IT deployment model included enterprise resources and applications stored within the data center 114 (i.e., physical devices) behind a firewall (perimeter), accessible by employees, partners, contractors, etc. on-site or remote via Virtual Private Networks (VPNs), etc. The cloud-based system 100 is replacing the conventional deployment model. The cloud-based system 100 can be used to implement these services in the cloud without requiring the physical devices and management thereof by enterprise IT administrators. As an ever-present overlay network, the cloud-based system 100 can provide the same functions as the physical devices and/or appliances regardless of geography or location of the users 102, as well as independent of platform, operating system, network access technique, network access provider, etc.

There are various techniques to forward traffic between the users 102 at the locations 112, 114, 118, and via the devices 110, 116, and the cloud-based system 100. Typically, the locations 112, 114, 118 can use tunneling where all traffic is forward through the cloud-based system 100. For example, various tunneling protocols are contemplated, such as Generic Routing Encapsulation (GRE), Layer Two Tunneling Protocol (L2TP), Internet Protocol (IP) Security (IPsec), customized tunneling protocols, etc. The devices 110, 116 can use a local application that forwards traffic, a proxy such as via a Proxy Auto-Config (PAC) file, and the like. A key aspect of the cloud-based system 100 is all traffic between the users 102 and the Internet 104 or the cloud services 106 is via the cloud-based system 100. As such, the cloud-based system 100 has visibility to enable various functions, all of which are performed off the user device in the cloud.

The cloud-based system 100 can also include a management system 120 for tenant access to provide global policy and configuration as well as real-time analytics. This enables IT administrators to have a unified view of user activity, threat intelligence, application usage, etc. For example, IT administrators can drill-down to a per-user level to understand events and correlate threats, to identify compromised devices, to have application visibility, and the like. The cloud-based system 100 can further include connectivity to an Identity Provider (IDP) 122 for authentication of the users 102 and to a Security Information and Event Management (SIEM) system 124 for event logging. The system 124 can provide alert and activity logs on a per-user 102 basis.

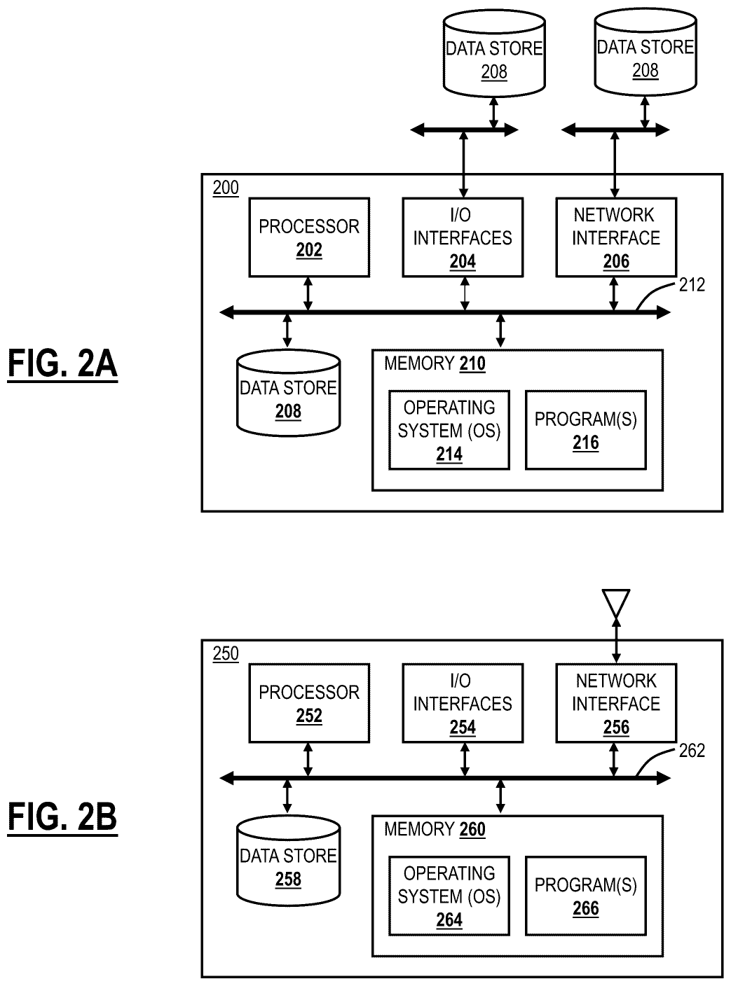

FIG. 1B is a network diagram of an example implementation of the cloud-based system 100. In an embodiment, the cloud-based system 100 includes a plurality of enforcement nodes (EN) 150, labeled as enforcement nodes 150-1, 150-2, 150-N, interconnected to one another and interconnected to a central authority (CA) 152. The nodes 150, 152, while described as nodes, can include one or more servers, including physical servers, virtual machines (VM) executed on physical hardware, etc. That is, a single node 150, 152 can be a cluster of devices. An example of a server is illustrated in FIG. 2. The cloud-based system 100 further includes a log router 154 that connects to a storage cluster 156 for supporting log maintenance from the enforcement nodes 150. The central authority 152 provide centralized policy, real-time threat updates, etc. and coordinates the distribution of this data between the enforcement nodes 150. The enforcement nodes 150 provide an onramp to the users 102 and are configured to execute policy, based on the central authority 152, for each user 102. The enforcement nodes 150 can be geographically distributed, and the policy for each user 102 follows that user 102 as he or she connects to the nearest (or other criteria) enforcement node 150.

The enforcement nodes 150 are full-featured secure internet gateways that provide integrated internet security. They inspect all web traffic bi-directionally for malware and enforce security, compliance, and firewall policies, as described herein. In an embodiment, each enforcement node 150 has two main modules for inspecting traffic and applying policies: a web module and a firewall module. The enforcement nodes 150 are deployed around the world and can handle hundreds of thousands of concurrent users with millions of concurrent sessions. Because of this, regardless of where the users 102 are, they can access the Internet 104 from any device, and the enforcement nodes 150 protect the traffic and apply corporate policies. The enforcement nodes 150 can implement various inspection engines therein, and optionally, send sandboxing to another system. The enforcement nodes 150 include significant fault tolerance capabilities, such as deployment in active-active mode to ensure availability and redundancy as well as continuous monitoring.

In an embodiment, customer traffic is not passed to any other component within the cloud-based system 100, and the enforcement nodes 150 can be configured never to store any data to disk. Packet data is held in memory for inspection and then, based on policy, is either forwarded or dropped. Log data generated for every transaction is compressed, tokenized, and exported over secure TLS connections to the log routers 154 that direct the logs to the storage cluster 156, hosted in the appropriate geographical region, for each organization.

The central authority 152 hosts all customer (tenant) policy and configuration settings. It monitors the cloud and provides a central location for software and database updates and threat intelligence. Given the multi-tenant architecture, the central authority 152 is redundant and backed up in multiple different data centers. The enforcement nodes 150 establish persistent connections to the central authority 152 to download all policy configurations. When a new user connects to an enforcement node 150, a policy request is sent to the central authority 152 through this connection. The central authority 152 then calculates the policies that apply to that user 102 and sends the policy to the enforcement node 150 as a highly compressed bitmap.

Once downloaded, a tenant's policy is cached until a policy change is made in the management system 120. When this happens, all of the cached policies are purged, and the enforcement nodes 150 request the new policy when the user 102 next makes a request. In an embodiment, the enforcement node 150 exchange “heartbeats” periodically, so all enforcement nodes 150 are informed when there is a policy change. Any enforcement node 150 can then pull the change in policy when it sees a new request.

The cloud-based system 100 can be a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “Software as a Service” (SaaS) is sometimes used to describe application programs offered through cloud computing. A common shorthand for a provided cloud computing service (or even an aggregation of all existing cloud services) is “the cloud.” The cloud-based system 100 is illustrated herein as an example embodiment of a cloud-based system, and other implementations are also contemplated.

As described herein, the terms cloud services and cloud applications may be used interchangeably. The cloud service 106 is any service made available to users on-demand via the Internet, as opposed to being provided from a company's on-premises servers. A cloud application, or cloud app, is a software program where cloud-based and local components work together. The cloud-based system 100 can be utilized to provide example cloud services, including Zscaler Internet Access (ZIA), Zscaler Private Access (ZPA), and Zscaler Digital Experience (ZDX), all from Zscaler, Inc. (the assignee and applicant of the present application). The ZIA service can provide the access control, threat prevention, and data protection described above with reference to the cloud-based system 100. ZPA can include access control, microservice segmentation, etc. The ZDX service can provide monitoring of user experience, e.g., Quality of Experience (QoE), Quality of Service (QOS), etc., in a manner that can gain insights based on continuous, inline monitoring. For example, the ZIA service can provide a user with Internet Access, and the ZPA service can provide a user with access to enterprise resources instead of traditional Virtual Private Networks (VPNs), namely ZPA provides Zero Trust Network Access (ZTNA). Those of ordinary skill in the art will recognize various other types of cloud services 106 are also contemplated. Also, other types of cloud architectures are also contemplated, with the cloud-based system 100 presented for illustration purposes.

### Example Server Architecture

FIG. 2A is a block diagram of a server 200, which may be used in the cloud-based system 100, in other systems, or standalone. For example, the enforcement nodes 150 and the central authority 152 may be formed as one or more of the servers 200. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 2A depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein.

### Example User Device Architecture

FIG. 2B is a block diagram of a user device 250, which may be used with the cloud-based system 100 or the like. Specifically, the user device 250 can form a device used by one of the users 102, and this may include common devices such as laptops, smartphones, tablets, netbooks, personal digital assistants, MP3 players, cell phones, e-book readers, IoT devices, servers, desktops, printers, televisions, streaming media devices, and the like. The user device 250 can be a digital device that, in terms of hardware architecture, generally includes a processor 252, I/O interfaces 254, a network interface 256, a data store 258, and memory 260. It should be appreciated by those of ordinary skill in the art that FIG. 2B depicts the user device 250 in an oversimplified manner, and a practical embodiment may include additional components and suitably configured processing logic to support known or conventional operating features that are not described in detail herein. The components (252, 254, 256, 258, and 252) are communicatively coupled via a local interface 262. The local interface 262 can be, for example, but not limited to, one or more buses or other wired or wireless connections, as is known in the art. The local interface 262 can have additional elements, which are omitted for simplicity, such as controllers, buffers (caches), drivers, repeaters, and receivers, among many others, to enable communications. Further, the local interface 262 may include address, control, and/or data connections to enable appropriate communications among the aforementioned components.

The processor 252 is a hardware device for executing software instructions. The processor 252 can be any custom made or commercially available processor, a CPU, an auxiliary processor among several processors associated with the user device 250, a semiconductor-based microprocessor (in the form of a microchip or chipset), or generally any device for executing software instructions. When the user device 250 is in operation, the processor 252 is configured to execute software stored within the memory 260, to communicate data to and from the memory 260, and to generally control operations of the user device 250 pursuant to the software instructions. In an embodiment, the processor 252 may include a mobile-optimized processor such as optimized for power consumption and mobile applications. The I/O interfaces 254 can be used to receive user input from and/or for providing system output. User input can be provided via, for example, a keypad, a touch screen, a scroll ball, a scroll bar, buttons, a barcode scanner, and the like. System output can be provided via a display device such as a Liquid Crystal Display (LCD), touch screen, and the like.

The network interface 256 enables wireless communication to an external access device or network. Any number of suitable wireless data communication protocols, techniques, or methodologies can be supported by the network interface 256, including any protocols for wireless communication. The data store 258 may be used to store data. The data store 258 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 258 may incorporate electronic, magnetic, optical, and/or other types of storage media.

The memory 260 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 260 may incorporate electronic, magnetic, optical, and/or other types of storage media. Note that the memory 260 may have a distributed architecture, where various components are situated remotely from one another, but can be accessed by the processor 252. The software in memory 260 can include one or more software programs, each of which includes an ordered listing of executable instructions for implementing logical functions. In the example of FIG. 2B, the software in the memory 260 includes a suitable operating system 264 and programs 266. The operating system 264 essentially controls the execution of other computer programs and provides scheduling, input-output control, file and data management, memory management, and communication control and related services. The programs 266 may include various applications, add-ons, etc. configured to provide end user functionality with the user device 250. For example, example programs 266 may include, but not limited to, a web browser, social networking applications, streaming media applications, games, mapping and location applications, electronic mail applications, financial applications, and the like. In a typical example, the end-user typically uses one or more of the programs 266 along with a network such as the cloud-based system 100.

### Machine Learning in Network Security

Machine learning can be used in various applications, including malware detection, intrusion detection, threat classification, the user or content risk, detecting malicious clients or bots, etc. In a particular use case, machine learning can be used on a content item, e.g., a file, to determine if further processing is required during inline processing in the cloud-based system 100. For example, machine learning can be used in conjunction with a sandbox to identify malicious files. A sandbox, as the name implies, is a safe environment where a file can be executed, opened, etc. for test purposes to determine whether the file is malicious or benign. It can take a sandbox around 10 minutes before it is fully determined whether the file is malicious or benign.

Machine learning can determine a verdict in advance before a file is sent to the sandbox. If a file is predicted as benign, it does not need to be sent to the sandbox. Otherwise, it is sent to the sandbox for further analysis/processing. Advantageously, utilizing machine learning to pre-filter a file significantly improves user experience by reducing the overall quarantine time as well as reducing workload in the sandbox. Of course, machine learning cannot replace the sandbox since malicious information from a static file is limited, while the sandbox can get a more accurate picture with dynamic behavior analysis. Further, it follows that the machine learning predictions require high precision due to the impact of a false prediction, i.e., finding a malicious file to be benign.

In the context of inline processing, sandboxing does a great job in detecting malicious files, but there is a cost in latency, which affects user experience. Machine learning can alleviate this issue by giving an earlier verdict on the static files. However, it requires ML to have extremely high precision, since the cost of a false positive and false negative are very high. For example, a benign hospital life-threatening file, if mistakenly blocked due to an ML model's wrong verdict, would cause a life disaster. Similarly, undetected ransomware could cause problems for an enterprise. Therefore, there is a need for a high-precision approach for both benign and malicious files.

The conventional approach to improve precision includes improving the probability threshold to increase precision. A p-value (probability value) is a statistical assessment for measuring the reliability of a prediction, but this does not identify the unreliability of predictions with high probabilities.

A description utilizing machine learning in the context of malware detection is described in commonly-assigned U.S. patent application Ser. No. 15/946,546, filed Apr. 5, 2018, and entitled “System and method for malware detection on a per packet basis,” the content of which is incorporated by reference herein. As described here, the typical machine learning training process collects millions of malware samples, extracts a set of features from these samples, and feeds the features into a machine learning model to determine patterns in the data. The output of this training process is a machine learning model that can predict whether a file that has not been seen before is malicious or not.

### Decision Tree

In an embodiment, a generated machine learning model is a decision tree. A trained model may include a plurality of decision trees. Each of the plurality of decision trees may include one or more nodes, one or more branches, and one or more termini. Each node in the trained decision tree represents a feature and a decision boundary for that feature. Each of the one or more termini is, in turn, associated with an output probability. Generally, each of the one or more nodes leads to another node via a branch until a terminus is reached, and an output score is assigned.

FIG. 3 is a diagram of a trained machine learning model 300. The machine learning model 300 includes one or more features 310 and multiple trees 320a, 320n. A feature is an individual measurable property or characteristic of a phenomenon being observed. The trees 320a, 320n can be decision trees associated with a random forest or a gradient boosting decision trees machine learning model. In various embodiments, the trees 320a, 320b are constructed during training. While the machine learning model 300 is only depicted as having trees 320a, 320n, in other embodiments, the machine learning model 300 includes a plurality of additional trees. The features 310, in the context of malicious file detection, relate to various properties or characteristics of the file.

The trees 320a, 320n include nodes 330a, 330b and termini 340a, 340b, 340c, 340d. That is, the node 330a is connected to termini 340a, 340b and the node 330b is connected to termini 340c, 340, via one or more branches. In other embodiments, the trees 320a, 320n include one or more additional nodes, one or more additional branches, and one or more additional termini. The nodes 330 each represent a feature and a decision boundary for that feature. The termini 340 can each be associated with a probability of maliciousness, in the example of malicious file detection. Generally, each of the one or more nodes leads to another node via a branch until a terminus is reached, and a probability of maliciousness is assigned. The output of the trained machine learning model 300 is a weighted average of a probability of maliciousness predicted by each of the trees 320a and the tree 320n.

### Transformer Models

Transformer models have fundamentally transformed the fields of natural language processing (NLP) and machine learning, offering substantial improvements over traditional neural network architectures. Introduced by Vaswani et al. in the groundbreaking 2017 paper “Attention is All You Need,” the transformer architecture centers around a mechanism called self-attention, which allows it to process and generate language with exceptional efficiency and accuracy. The self-attention mechanism is the core innovation, enabling the model to evaluate the importance of different words in a sentence relative to one another. This capability allows transformers to capture long-range dependencies and contextual relationships within the text, overcoming the limitations of earlier models such as recurrent neural networks (RNNs) and long short-term memory (LSTM) networks, which struggled with long-term dependencies.

The transformer architecture typically features an encoder-decoder structure. The encoder processes the input sequence and generates attention-weighted representations, while the decoder uses these representations to produce the output sequence. Each encoder and decoder layer includes a multi-head self-attention mechanism and a position-wise fully connected feed-forward network, complemented by layer normalization and residual connections. To account for word order, transformers use positional encoding in the input embeddings, enabling the model to understand sequence order and relationships among words.

Unlike RNNs, which process tokens sequentially, transformers allow for parallel processing of input data, significantly speeding up training times and enabling the handling of much larger datasets. Transformers are highly scalable and can be trained on vast datasets, leading to the development of large pre-trained language models such as BERT, GPT, and T5, which have set new performance benchmarks on various NLP tasks. Additionally, the transformer architecture is not confined to NLP tasks and has been successfully applied to other domains, including image processing (Vision Transformers), speech recognition, and reinforcement learning.

Transformers form the backbone of modern translation systems, offering more accurate and fluent translations than previous models. Models like GPT-3, built on the transformer architecture, can generate coherent and contextually relevant text, enabling applications in content creation, conversational agents, and more. Transformers excel at understanding context and nuances in text, making them ideal for tasks such as sentiment analysis, spam detection, and document classification. Pre-trained transformer models like BERT and T5 have set new standards in question answering and text summarization tasks.

Notable transformer models include Bidirectional Encoder Representations from Transformers (BERT) which uses a bidirectional approach to understand context from both directions in a sentence, significantly improving performance on various NLP benchmarks. The Generative Pre-trained Transformer (GPT) series, focusing on generative tasks, has demonstrated remarkable capabilities in text generation and completion. Further, Text-To-Text Transfer Transformer T5 treats every NLP problem as a text-to-text problem, unifying various tasks under a single framework.

### URL Filtering/Content Classification

With URL filtering, IT can limit exposure to liability by managing access to Web content based on a site's categorization. The URL filtering policy includes per-tenant definable rules that include criteria, such as URL categories, users, groups, departments, locations, and time intervals. There is also a recommended (default) policy for URL filtering. To allow granular control of filtering, the URLs can be organized into a hierarchy of categories. In an embodiment, there can be high-level classes, which are then each divided into predefined super-categories, and then further divided into predefined categories. The classes may be functional, such as bandwidth loss, business use, general surfing, legal liability, productivity loss, and privacy risk. Super-categories may include high-level identifiers such as entertainment, business, education, IT, communications, government, news, adult, gambling, shopping, social, games, sports, etc. The categories may further include more granular identifiers, e.g., media streaming, marketing, stock trading, blogs, type of adult content, copyright infringement, profanity, etc. Those skilled in the art will recognize there can be any level of classification, and any such level or granularity is contemplated herein. That is, any number of categories and hierarchy of categories is contemplated.

The cloud-based system 100, offering a service for URL filtering, can be configured to take specific action based on a classification of a URL, such as:

Allow: The service allows access to the URLs in the selected categories. One can still restrict access by specifying a daily quota for bandwidth and time. For example, one can allow users to access Entertainment and Recreation sites but restrict the bandwidth allowed for these sites, so they do not interfere with business-critical applications. The daily time quota can be based on the time that the rule is created. For example, if the rule is created at 11 a.m. PST, then the quota is renewed at 11 a.m. PST the next day.

Caution: When a user tries to access a site, the service displays a Caution notification. One can use the system-defined notification, customize the text, or create user-defined notifications and direct users to it.

Block: The service displays a Block notification. One can use the system-defined notification, customize the text, or create your notification and direct users to it. Additionally, one can allow some users or groups to override the block with the Allow Override option. For example, one can block students from going to YouTube but allow the teachers. Teachers will be prompted to enter their override password. This can be company provided credentials such as single sign-on credentials or hosted database credentials based on the Enable Identity-based Block Override settings.

### Dynamic Content Categorization

The present disclosure includes a machine learning technique to classify a Web page as containing content related to one of a plurality of categories. This is advantageous as new URL content is ever-evolving. In the context of the cloud-based system 100, if a new URL is uncategorized, the present disclosure can be used to provide a categorization quickly. Thus, the cloud-based system 100 is not constrained to only categorizing URLs that are already classified. The approach generally includes training a machine learning model offline, such as with training data labeled according to the URL category. A new URL is loaded, the Web page is parsed, words and other characteristics of the Web page are extracted, and the words and other characteristics are analyzed with the machine learning model offline to output a predicted category. This machine learning process in production must be quick to avoid latency between a user request and an answer (block/allow) by the cloud-based system 100.

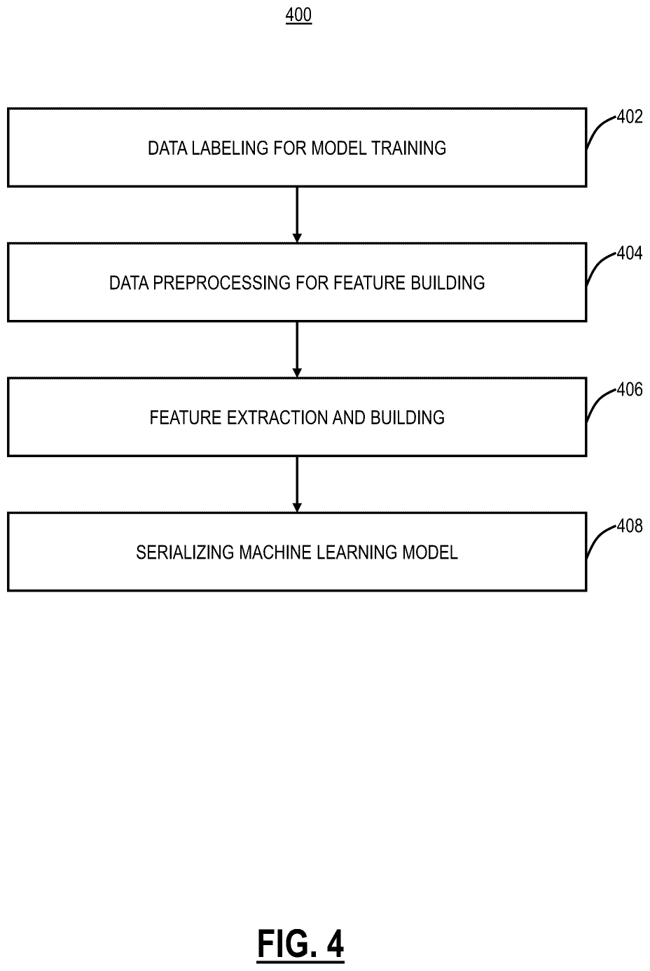

FIG. 4 is a flowchart of a model training process 400 for URL content classification. The model training process 400 includes data labeling for model training (step 402), data preprocessing for feature building (step 404), feature extraction and building (step 406), and serializing a machine learning model (step 408). The model training process 400 contemplates implementation as a method, via a server 200, and as a non-transitory computer-readable storage medium having computer-readable code stored thereon for programming one or more processors to perform steps.

Of note, the model training process 400 leverages the cloud-based system 100 and the fact the cloud-based system is multi-tenant, has a large number of users 102, and can process tens or hundreds of billions of transactions or more a day. That is, the cloud-based system 100 has a large data set of URL transactions. The cloud-based system 100 can utilize a database of known URL classifications. This can be managed by the central authority 152 and promulgated to each of the enforcement nodes 150. The present disclosure is focused on classifying new URLs and their content such that the new URLs can be added to the database of known URL classifications. Again, the reach and extent of the cloud-based system 100 enables the detection of unknown URLs as they pop up. The large data set can be stored in the storage cluster 156 and used herein for model training.

Each of the steps in the model training process 400 is now described in detail.

### Data Labeling for Model Training

The data labeling for model training step 402 includes obtaining data from the cloud-based system 100 for training a machine learning model via supervised learning. That is, the cloud-based system 100 has a large amount of data based on ongoing monitoring, and this data can be leveraged to train a model. The data labeling for model training step 402 includes running a big data query on the URL transactions in the storage cluster 156 and filtering out websites relevant to specific categories. Here, it is possible to obtain a large amount of data that can be labeled with specific URL categories.

The data labeling for model training step 402 can also include validation of the data. This can include running scripts on the data to validate the existence of domains and running scripts that may use third party services to validate the websites.

The data labeling for model training step 402 can also include arranging the data such as arranging the websites in order of their content size, such as in descending order.

Finally, the data labeling for model training step 402 can include using scripts as well as human-based verification to validate the URLs in the data match the category they are assigned to. The objective here is to make sure the data for training is properly labeled.

An output of the data labeling for model training step 402 is a set of URLs, with each being assigned to a category of a plurality of categories.

### Data Preprocessing for Feature Building

A feature is an individual measurable property or characteristic of a website. For an effective machine learning model, it is important to choose informative, discriminating, and independent features. For URL classification, each feature can be anything that is measurable and representable numerically. The data preprocessing for feature building step 404 relates to manipulating the data from raw Hypertext Markup Language (HTML) files for each URL from the data. The manipulating involves processing the raw HTML files for feature extraction and building.

The data preprocessing for feature building step 404 includes obtaining a raw HTML file for each URL in the set of URLs. This can be accomplished by loading each URL and storing the raw HTML file. Each of the raw HTML files is assigned the same category as the URL category from the data labeling for model training step 402,

For each of the raw HTML files, the data preprocessing for feature building step 404 performs data preprocessing. This means the raw data is manipulated to better allow the raw data to be used for features. That is, preprocessing means processing data in the raw HTML files and the pre means before the features are extracted/built. An output of the data preprocessing for feature building step 404 is data for each URL with an associated category, where the data is ready for feature extraction.

The preprocessing can include extracting specific/relevant HTML tags from the raw HTML files. The preprocessing can include converting all extracted data to text (e.g., images, etc. can be recognized), converting all words to lowercase (or uppercase, as long as it is uniform), performing tokenization, and the like. The preprocessing can also include removing various data that is not relevant to features including, for example, special characters (e.g., <>, ;, “”, etc.), numbers, cities/countries/places/etc., names, header and footer data, and the like. Also, the preprocessing can include combing all hyphens (i.e., -) to single words (e.g., abc-def→abcdef). Further, the preprocessing can include removing frequent words that do not contain much information, such as “a,” “of,” “the,” etc. Finally, the preprocessing can include reducing words to their stem (e.g., “play” from “playing”) using various stemming techniques.

Again, after the data preprocessing for feature building step 404, the raw HTML files are now a series of words with an associated category.

### Feature Extraction/Building

The feature extraction and building step 406 utilizes the output from the data preprocessing for feature building step 404, namely the series of words with an associated category. The feature extraction and building step 406 is building features for each category and uses the series of words for each URL for each category.

The feature extraction and building step 406 includes cleaning input text and tokenizing using the tokenizer. This can then be inputted into the transformer model for classification.

### Serializing

Finally, with all of the relevant features for each category of URL classification, the model training process 400 includes the serializing machine learning model step 408. In an embodiment, the present disclosure can utilizes the Light Gradient Boosted Machine (LightGBM) model, or BERT-tiny for the classification stage. LightGBM is an open-source distributed gradient boosting framework for machine learning originally developed by Microsoft. It is based on decision tree algorithms and used for ranking, classification and other machine learning tasks. Here, the model training process 400 includes marshaling the LightGBM model into a flat buffer decision tree structure based on the extracted features.

BERT-tiny is a smaller, more efficient variant of the BERT model, designed to provide faster inference times and lower computational costs while maintaining reasonable performance levels. BERT-tiny retains the core architecture and bidirectional context understanding of the original BERT model but significantly reduces the number of layers and parameters. Typically, BERT-tiny consists of 2 layers, 128 hidden units, and 2 attention heads, compared to the original BERT-base model's 12 layers, 768 hidden units, and 12 attention heads. This reduction in size makes BERT-tiny suitable for applications with limited computational resources, such as mobile devices or edge computing, where deploying full-sized BERT models would be impractical. Despite its compact size, BERT-tiny can still perform well on various NLP tasks, offering a good balance between efficiency and accuracy.

### URL Content Classification Process

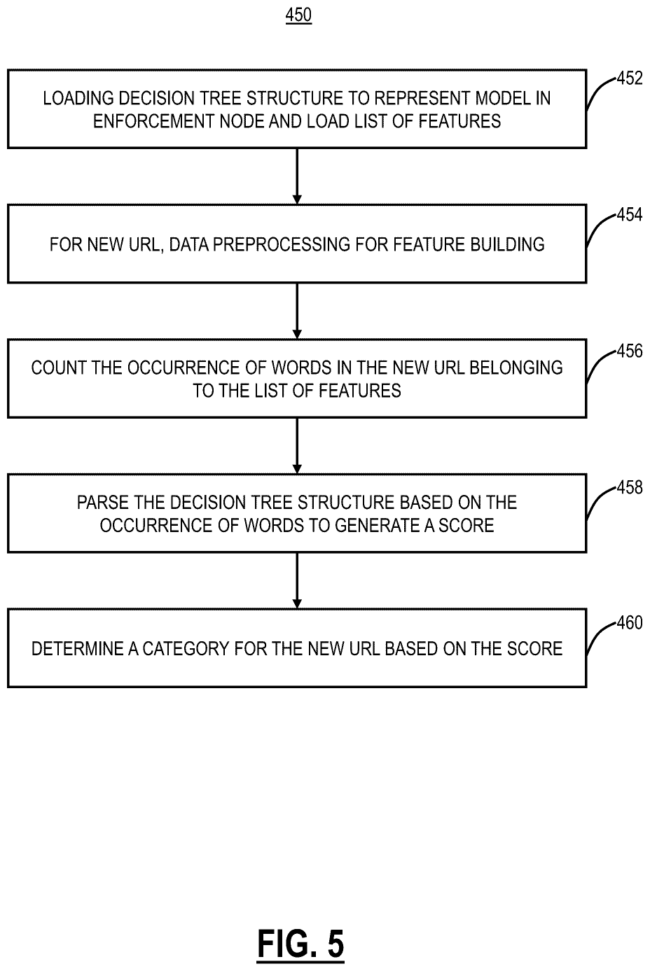

FIG. 5 is a flowchart of a URL content classification process 450. The URL content classification process 450 contemplates implementation as a method, via a server 200, and as a non-transitory computer-readable storage medium having computer-readable code stored thereon for programming one or more processors to perform steps. In an embodiment, the URL content classification process 450 contemplates operation via an enforcement node 150 in the cloud-based system 100. Specifically, the URL content classification process 450 utilizes a trained machine learning model, such as one from the model training process 400.

The cloud-based system 100, via the enforcement node 150, can be configured for inline monitoring of the users 102. One aspect of this inline monitoring can be to allow/block URL content based on policy, i.e., specific categories. The cloud-based system 100 can include a database of known URL categories for URLs. The URL content classification process 450 can be implemented to classify the content of an unknown URL.

The URL content classification process 450 includes loading a decision tree structure to represent the model in an enforcement node 150 and loading a list of features (step 452). Here, an in-memory decision tree structure is formed in the enforcement nodes 150 to represent the machine learning model.

For a new URL, i.e., uncategorized URL, the URL content classification process 450 includes data preprocessing for feature building (step 454). This step is similar to the data preprocessing for feature building step 404 to process a raw HTML file associated with the new URL.

The URL content classification process 450 includes counting the occurrence of words in the new URL belonging to the list of features in the decision tree structure (step 456).

The URL content classification process 450 includes parsing the decision tree structure based on the occurrence of words to generate a score (step 458).

The URL content classification process 450 includes determining a category for the new URL based on the score (step 460).

Finally, the URL content classification process 450 can store the determined category in the database for future categorization.

### Inline URL Categorization

The present disclosure further provides systems and methods for inline URL categorization. Inline meaning content classification/categorization can be performed for user traffic inline, i.e., between the source and the destination, with reduced latency. The inline content classification/categorization described herein can be performed by one or more processors associated with and/or communicatively coupled to the cloud-based system 100. More particularly, the specialized algorithms and methods described herein can be performed via one or more processors associated with servers 200, nodes 150, etc. of the cloud-based system 100 for providing the functionality to customers of the cloud-based system 100 for enforcing policy on traffic. Again, such policy can cause, based on a classification, the traffic to be blocked, allowed, quarantined, etc.

Various embodiments for optimizing and streamlining ML/deep learning models for inline URL categorization include improved tokenizer implementation without compromising performance, utilization of lightweight models, using token vocabulary mapping for language-based content filtering, and sentence embedding with cosine similarity techniques to detect data leakage.

Again, the present systems and methods are adapted to classify websites inline based on the text content therein. Further, policies are leveraged to enforce blocking certain types of websites based on a determined category. A key aspect of the present systems and methods include training lightweight models to outperform current, more computationally expensive models. As described, the present cloud-based system 100 can leverage datasets with over a million websites which contain a plurality of languages.

Traditionally, standard models utilize a word-piece tokenizer which tries to combine tokens to replace unknown words, i.e., words that are not present in the models vocabulary. In a deployment environment, where strict latency requirements are enforced, this step can become a bottleneck. This is particularly pertinent in an inline implementation. By employing a novel technique during model training, the present systems and methods can streamline this step with minimal impact on performance. In various embodiments, this technique includes an improved tokenization implementation to determining a first “N” complete words which are part of the vocabulary of the lightweight model, and utilize them as the input. Further, any unknown words are skipped and no “UNK” token is used. The normal BERT tokenizer is based on a vocabulary of ˜30 k tokens which is used to convert words to single tokens (for words which exist in the vocabulary) or sub words for words which don't exist (if this is also not possible with the vocabulary, the word is tokenized using [UNK] token).

Instead of this, the present process includes removing the tokens which are primarily used for sub words (these start with ##, eg. “##ization”), and then replacing the process as a lookup in the vocabulary file. Thus, for each word in the input, the systems look if the exact word is present in the vocab, then it can be added, otherwise it is skipped altogether (the model does not use the [UNK] token). This is done until 128 known tokens are found or until the system has processed all the words in the input text.

The following table shows the performance characteristics when utilizing such techniques compared to a standard model.

| | F1 Score | Precision | Recall | Avg. Latency |
|---|---|---|---|---|
| Normal | 0.70 | 0.82 | 0.62 | 10.7 ms |
| Light-tokenizer | 0.69 | 0.82 | 0.61 | 5 ms |

From the table above, it can be seen that employing the present tokenizer implementation greatly reduces the latency of the model while minimally reducing the performance of the model.

Additionally, in various embodiments, lightweight models can be trained with carefully curated data to achieve performance that is comparable to much larger models. In various embodiments, the curated data can be collected primarily through a manual curation process, where a team of curators filter through the contents of the webpage and then assign it to its relevant class/category. For example, a lightweight model, such as the Lightweight Bidirectional Encoder Representations from Transformers (BERT-tiny) model, can be trained with such techniques making them easily deployable on a lightweight environment while running with very low latency. The following table presents performance metrics and model size across various models.

| Model | Model Size | F1 Score | Precision | Recall |
|---|---|---|---|---|
| Model 1 | 17.6 MB | 0.69 | 0.82 | 0.61 |
| Model 2 | 44.8 MB | 0.71 | 0.83 | 0.64 |
| Model 3 | 90 MB | 0.71 | 0.83 | 0.63 |

From the table above, it can be seen that even when utilizing a much smaller model, the performance can be comparable to larger models. Again, this performance is due to the amount of data available to the cloud-based system 100. For example, the amount of data available exceeds 500 k relevant curated examples, allowing the present processes to achieve the performance of a much larger model with much lighter weight models such as BERT-tiny.

In various embodiments, the lightweight model can be adapted to function with respect to one or more specific languages. That is, the token vocabulary mapping can be language based, thus, the present URL categorization can be adapted to filter out specific languages and not run the model for websites in other languages. For example, the token vocabulary mapping can be utilized to cause a model to work only for English language content. Thus, all websites in other languages will be bypassed or processed by another model specialized in the identified language. To facilitate such functionality, in various embodiments, a language classification model/system can be contemplated for classifying the language of a website prior to the classification/categorization model receiving the URL/website. Although accurate, such a step can cause further latency issues. To solve such latency issues, various embodiments include performing, in the preprocessing step, a check for a preconfigured number of words that belong to a specific language. For example, since the lightweight model's vocabulary contains only about 22 k English words, the systems can check for at least 30 existing vocabulary tokens associated with the English language in the input text, thus, any website in another language will fail this test, and an inherent language filter is thus provided. That is, during the tokenization stage, the algorithm can be adapted to look for a specific threshold number of words that are associated with a specific language. Based thereon, if the threshold is satisfied, the website can be processed further, if not satisfied, the website can be bypassed, i.e., classification will not occur for the website. In the example described above, the desired language is English and the defined word threshold is 30, thus, if during the tokenization stage 30 or more English words are identified, the process will continue to classify the website, if less than 30 English words are identified, the website will be bypassed, and inline URL classification will not happen. In various embodiments, a plurality of lightweight models can be trained for various languages, thus. If a URL satisfies the language filtering for a specific language, a specialized lightweight model can be utilized for that specific URL. It will be appreciated that the present language filter process can be adapted for any language, and the required number of vocabulary tokens within a website can be configured as any number for filtering purposes.

Tokenization is a fundamental process in natural language processing (NLP) that involves breaking down text into smaller units known as tokens. These tokens can vary in granularity, including words, phrases, or even individual characters, depending on the specific requirements of the task. Word tokenization, for instance, splits a sentence into individual words, such as converting “Tokenization is important” into [“Tokenization”, “is”, “important”]. Sentence tokenization, on the other hand, divides text into separate sentences, turning “Hello world. How are you?” into [“Hello world.”, “How are you?”].

In more advanced scenarios, sub-word tokenization is employed to break words into smaller components like prefixes, suffixes, or even individual characters, which is particularly useful for managing rare words or languages with complex morphology. For example, the word “unhappiness” might be segmented into [“un”, “happiness”] or even [“un”, “hap”, “pi”, “ness”]. Additionally, character tokenization decomposes text into its constituent characters, turning “Hello” into [“H”, “e”, “I”, “I”, “o”]. Tokenization is crucial as it converts raw text into a structured format that is more amenable to processing by machine learning models and other NLP tools, facilitating tasks such as text analysis, machine translation, and information retrieval. Thus, as described, the language filter/classification can be built into the tokenization step, mitigating the need for a separate language classification step.

Further, in various embodiments, the present systems and methods are further adapted to mitigate data leakage between training and testing sets when training ML models. In cases where datasets include websites, proper segregation is practiced by not allowing the same websites to be present in the training and testing sets. Although, there is still risk that some unsuspected leakage will occur. This can include different websites of the same parent company, product websites that are very similar, etc. The present systems mitigate these issues by encoding the website content into an embedding using sentence transformers and then cosine similarity can be checked between training and testing data. Using this approach, tests identified that approximately 5% of the test dataset closely resembled some training data points, despite implementing stringent preprocessing checks to prevent leakage.

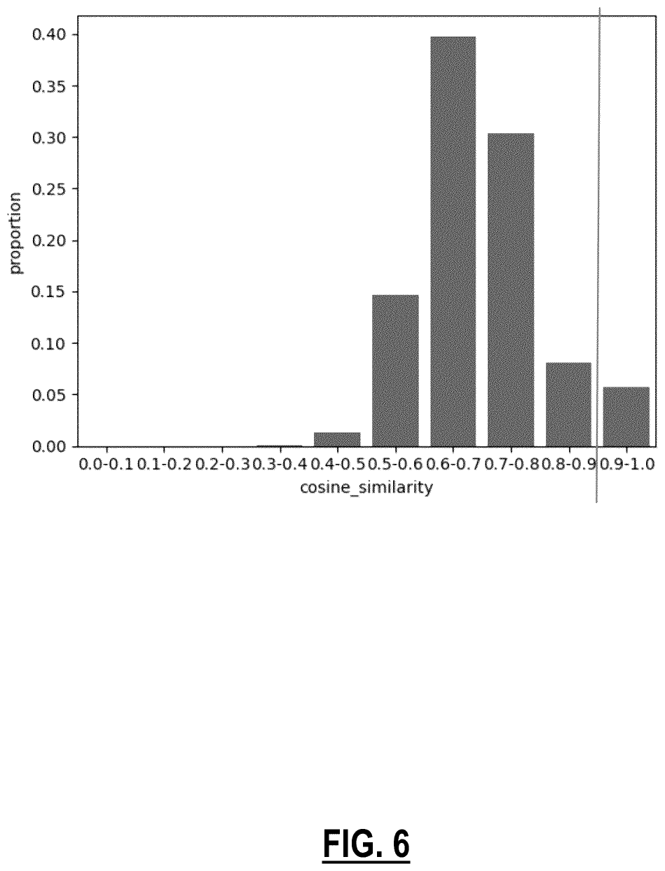

FIG. 6 is a graph showing the distribution of cosine similarity of test datapoints with their most similar counterpart in a training set. It can be seen that around 5% of the test dataset had a cosine similarity of more than 0.9 with at least one example from the training dataset.

Based on the various optimizations described herein including an improved tokenization implementation, utilization of curated training data, language-based content filtering, and data leakage detection, the present URL categorization can be implemented inline in a cloud-based system 100 without introducing undesirable latency.

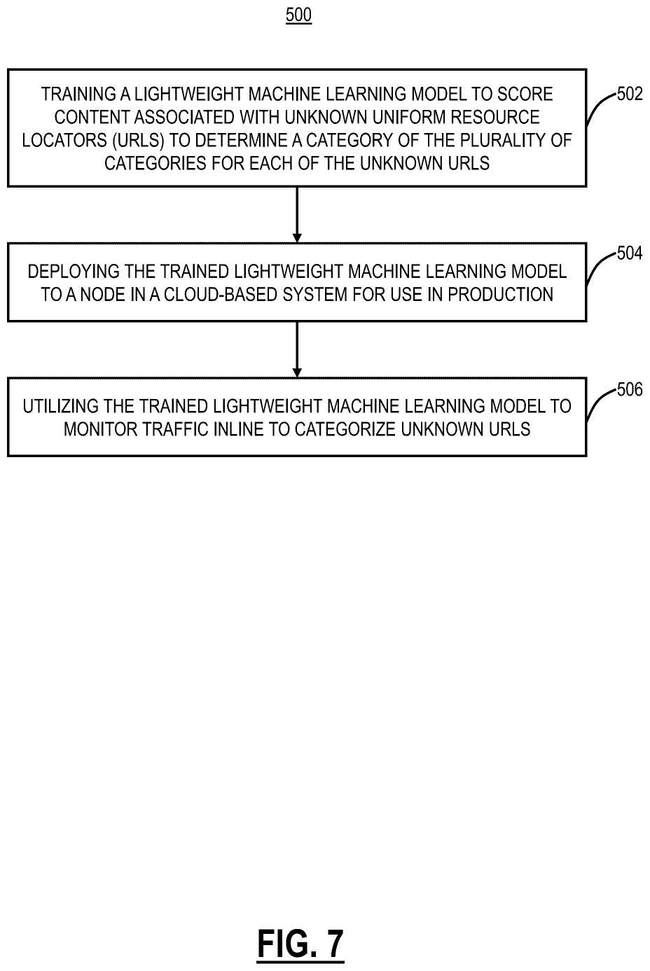

FIG. 7 is a flowchart of an Inline URL categorization process 500. The process 500 includes training a lightweight machine learning model to score content associated with unknown Uniform Resource Locators (URLs) to determine a category of the plurality of categories for each of the unknown URLs (step 502); deploying the trained lightweight machine learning model to a node in a cloud-based system for use in production (step 504); and utilizing the trained lightweight machine learning model to monitor traffic inline to categorize unknown URLs (step 506).

The process 500 can further include obtaining curated data from URL transactions monitored by a cloud-based system; labeling the curated data for the URL transactions with a category of a plurality of categories that describe content of a page associated with the URL; performing preprocessing of raw Hypertext Markup Language (HTML) files for the URL transactions; extracting features from the preprocessed raw HTML files; and training the lightweight machine learning model based on the features. The steps can further include utilizing an improved tokenizer implementation. The curated data can include URLs, extracted text, and a category assigned by a curator. The steps can further include performing inline language-based content filtering and performing URL categorization based thereon. The steps can include utilizing one of a plurality of machine learning models based on the language-based content filtering. The language-based content filtering can be performed during a preprocessing stage. An unknown URL can be bypassed based on the language-based content filtering. The steps can further include encoding website content into an embedding; and performing a cosine similarity check between a training dataset and a testing dataset. The lightweight machine learning model can be a Lightweight Bidirectional Encoder Representations from Transformers (BERT-tiny) model.

### Conclusion

It will be appreciated that some embodiments described herein may include one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application-Specific Integrated Circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various embodiments.

Moreover, some embodiments may include a non-transitory computer-readable storage medium having computer-readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a Read-Only Memory (ROM), a Programmable Read-Only Memory (PROM), an Erasable Programmable Read-Only Memory (EPROM), an Electrically Erasable Programmable Read-Only Memory (EEPROM), Flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims.

What is claimed is:

1. A non-transitory computer-readable storage medium having computer-readable code stored thereon for programming one or more processors to perform steps of:
training a lightweight machine learning model to score content associated with unknown Uniform Resource Locators (URLs) to determine a category of the plurality of categories for each of the unknown URLs;
deploying the trained lightweight machine learning model to a node in a cloud-based system for use in production; and
utilizing the trained lightweight machine learning model to monitor traffic inline to categorize unknown URLs.

2. The non-transitory computer-readable storage medium of claim 1, wherein the training comprises:
obtaining curated data from URL transactions monitored by a cloud-based system;
labeling the curated data for the URL transactions with a category of a plurality of categories that describe content of a page associated with the URL;
performing preprocessing of raw Hypertext Markup Language (HTML) files for the URL transactions;
extracting features from the preprocessed raw HTML files; and
training the lightweight machine learning model based on the features.

3. The non-transitory computer-readable storage medium of claim 2, wherein the preprocessing comprises:
utilizing a tokenizer implementation for reducing the number of tokens utilized by the trained lightweight machine learning model.

4. The non-transitory computer-readable storage medium of claim 2, wherein the curated data comprises URLs, extracted text from webpages, and categories assigned by curators.

5. The non-transitory computer-readable storage medium of claim 1, wherein the steps comprise:
performing inline language-based content filtering and performing URL categorization based thereon.

6. The non-transitory computer-readable storage medium of claim 5, wherein the steps comprise utilizing one of a plurality of machine learning models based on the language-based content filtering.

7. The non-transitory computer-readable storage medium of claim 5, wherein the language-based content filtering is performed during a preprocessing stage.

8. The non-transitory computer-readable storage medium of claim 5, wherein an unknown URL is bypassed based on the language-based content filtering.

9. The non-transitory computer-readable storage medium of claim 1, wherein the training comprises:
encoding website content into an embedding; and
performing a cosine similarity check between a training dataset and a testing dataset.

10. The non-transitory computer-readable storage medium of claim 1, wherein the lightweight machine learning model is a Lightweight Bidirectional Encoder Representations from Transformers (BERT-tiny) model.

11. A method for inline Uniform Resource Locator (URL) categorization, the steps comprising:
training a lightweight machine learning model to score content associated with unknown Uniform Resource Locators (URLs) to determine a category of the plurality of categories for each of the unknown URLs;
deploying the trained lightweight machine learning model to a node in a cloud-based system for use in production; and
utilizing the trained lightweight machine learning model to monitor traffic inline to categorize unknown URLs.

12. The method of claim 11, wherein the training comprises:
obtaining curated data from URL transactions monitored by a cloud-based system;
labeling the curated data for the URL transactions with a category of a plurality of categories that describe content of a page associated with the URL;
performing preprocessing of raw Hypertext Markup Language (HTML) files for the URL transactions;
extracting features from the preprocessed raw HTML files; and
training the lightweight machine learning model based on the features.

13. The method of claim 12, wherein the preprocessing comprises:
utilizing a tokenizer implementation for reducing the number of tokens utilized by the trained lightweight machine learning model.

14. The method of claim 12, wherein the curated data comprises URLs, extracted text from webpages, and categories assigned by curators.

15. The method of claim 11, wherein the steps comprise:
performing inline language-based content filtering and performing URL categorization based thereon.

16. The method of claim 15, wherein the steps comprise utilizing one of a plurality of machine learning models based on the language-based content filtering.

17. The method of claim 15, wherein the language-based content filtering is performed during a preprocessing stage.

18. The method of claim 15, wherein an unknown URL is bypassed based on the language-based content filtering.

19. The method of claim 11, wherein the training comprises:
encoding website content into an embedding; and
performing a cosine similarity check between a training dataset and a testing dataset.

20. The method of claim 11, wherein the lightweight machine learning model is a Lightweight Bidirectional Encoder Representations from Transformers (BERT-tiny) model.
